(19) United States
(12) Patent Application Publication
(10) Pub. No.: US 2006/0081655 A1
(43) Pub. Date: Apr. 20, 2006

(54) Fixing device and dispenser comprising same

(76) Inventors: Stephane Beranger, Le Neubourg (FR); Eirmin Garcia, Evreux (FR)

Correspondence Address: SUGHRUE MION, PLLC, 2100 PENNSYLVANIA AVENUE, N.W., SUITE 800, WASHINGTON, DC, 20037, US

(21) Appl. No.: 10/530,346

(22) PCT Filed: Oct. 6, 2003
(86) PCT No.: PCT/FR03/02924

§ 371 Date: Apr. 6, 2005

(30) Foreign Application Priority Data
Oct. 7, 2002 (FR) 02/12416

(51) Int. Cl. G01F 11/36

(52) U.S. Cl. 222/321.9

(57) ABSTRACT

A fastener device (1) for fastening a fluid dispenser member (2) on a reservoir neck (3) having an inner wall (31) and a top end-wall (32), said fastener device including receiver means (10) adapted to receive a dispenser member (2) in secure manner, and fastener means (14, 15) capable of becoming engaged with the reservoir neck (3), the fastener means including an adhesive-coated application zone (14) capable of coming into contact with the reservoir neck (3), said device being characterized in that the adhesive-coated application zone (14) is designed to come into contact with the top end-wall (32) of the neck (3).

The present invention relates to a fastener device for fastening a dispenser member on a reservoir neck, and to a dispenser comprising a reservoir, a dispenser member, and a fastener device of the invention.

It is commonplace in the fields of perfumery, cosmetics, or even pharmacy to use a fastener device for fastening a dispenser member such as a pump or a valve in a reservoir opening which is often in the form of a neck. The neck generally has an inner wall, an outer wall, and a top end-wall connecting the inner wall to the outer wall. The fastener device generally includes receiver means adapted to receive the body of the pump or valve in secure manner. In conventional manner, the pump or valve body is force-fitted into a snap-fastener housing formed by the receiver means. In addition, the fastener device includes fastener means capable of becoming engaged with the neck or the opening of the reservoir, so as to be held securely therein. Various techniques exist enabling the fastener device to be fastened on or in the reservoir neck or opening. By way of example, the fastener means can be in the form of a skirt that is split or continuous and that becomes engaged with the outer wall of the neck. By way of example, the split or continuous skirt can by formed with internal snap-fastener heads which are received below a shoulder formed by the outer wall of the neck. Another fastening technique consists in providing the fastener device with a sleeve which becomes engaged with the inner wall of the neck, either merely by clamping, or by combined clamping and snap-fastening action.

In addition to its fastening function, such a fastener device must normally still fulfill a sealing function, so as to prevent any fluid from leaking between the neck of the reservoir and the fastener device. A well known technique for providing sealing is to use a neck gasket disposed in conventional manner on the top end-wall of the neck. In most prior-art fastener devices, the fastening function is always disassociated from the sealing function: in other words, the fastener means do not guarantee sealing, and the sealing means do not guarantee fastening.

An object of the present invention is to remedy the above-mentioned drawback of the prior art, by defining a fastener device having fastener means that simultaneously provide the sealing function.

In the prior art, document WO 84/01356 describes a fastener cup for fastening a valve on an aerosol container. The cup is completely coated in a plastics material which can easily be heated to a high temperature so as to form a seal between the cup and the container. The melting temperature of the plastics material coated on the cup is about 600° F., or 315° C. The plastics materials used are those that are capable of melting onto a metal surface. The plastics materials mentioned are polyethylene, propylene, vinyl, nylon, acetate, or other plastics materials. The plastics materials are therefore fastened by melting onto the metal surface by applying intense heat.

An object of the present invention is to provide simultaneous fastening and sealing without applying heat, since high temperatures are harmful to the fluid to be dispensed.

The present invention achieves this object by proposing fastener means including an adhesive-coated application zone capable of coming into contact with the reservoir neck. More simply, the fastener device is adhesively bonded onto the reservoir neck. Adhesion simultaneously provides fastening and sealing. Advantageously, the adhesive-coated application zone is designed to come into contact with the top end-wall of the neck. In practical manner, the fastener device includes an annular flange having a bottom face defining the application zone. The annular flange is also referred to as a “plate”. It is easy to press the plate hard against the top end-wall of the neck with a conventional press tool. It can thus be said that, in the present invention, the conventional neck gasket of the prior art has been replaced by an adhesive, which, in addition to its sealing function, also fulfills a fastening function.

According to another aspect of the invention, the fastener device includes an inner sleeve designed to come into leaktight engagement with the inner wall of the neck. The function of the inner sleeve is to isolate the adhesive from the fluid stored inside the reservoir. In many applications, the fluid can be contaminated by certain constituent components of the adhesive. The inner sleeve thus constitutes a barrier preventing the fluid from coming into contact with the adhesive. Furthermore, it completes or reinforces the sealing at the reservoir neck.

According to another characteristic of the invention, the fastener device includes an outer skirt designed to extend around an outer wall of the neck. The outer skirt can contribute to fastening and/or to sealing the fastener device on the neck of the receptacle. By way of example, the skirt can improve the stability of the fastener device. Although not essential, the outer skirt may include hook means capable of co-operating with the outer wall of the neck. The fastening function can be guaranteed entirely by the adhesive. Another possible function of the skirt is to serve as a support for a covering band, which covers it so as to improve the appearance of the fastener device, and consequently of the dispenser as a whole. The covering band can be force-fitted around the outer skirt.

In a practical embodiment, the inner sleeve and the outer skirt together form an annular groove having a bottom that is formed by the bottom face of the annular flange which connects the sleeve to the skirt. The adhesive can thus be deposited or applied very simply on the bottom of the annular groove.

The adhesive is advantageously a cold adhesive. By way of example, the adhesive can be a liquid or paste, or a double-sided adhesive tape deposited on the application zone. Such adhesives require no heat to be applied or given off, which might be harmful to the fluid.

The invention also provides a fluid dispenser comprising a fluid dispenser member, a reservoir, and a fastener device of the invention. Advantageously, the dispenser member is a pump, the reservoir is made of glass or of plastics material, and the fastener device is made of plastics material.

The invention is described more fully below with reference to the accompanying drawings which show two embodiments of the invention by way of non-limiting example.

In the figures:

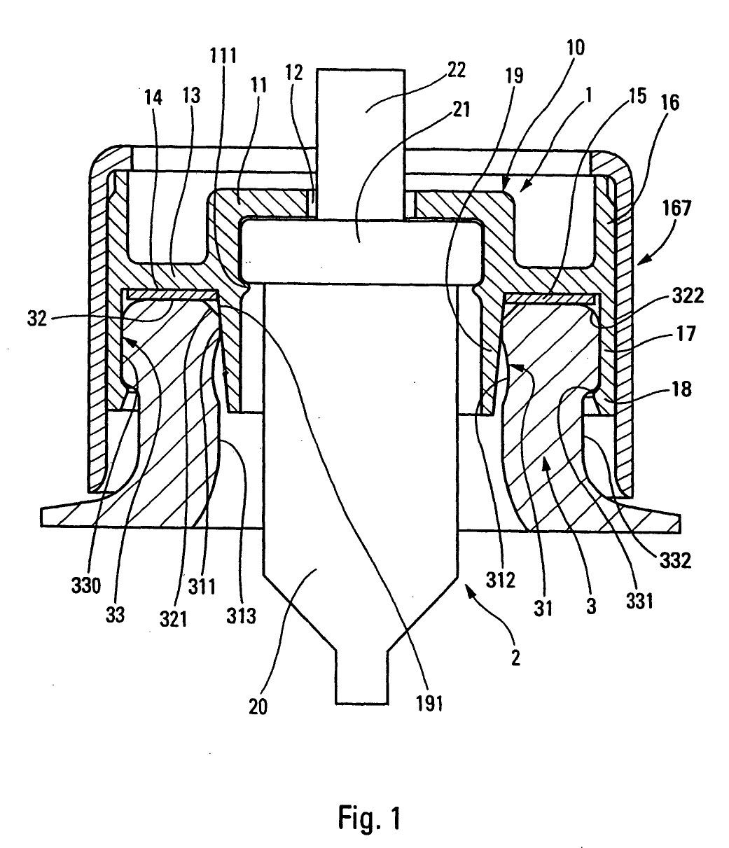

FIG. 1 is a vertical section view through the top portion of a fluid dispenser constituting a first embodiment of the invention; and

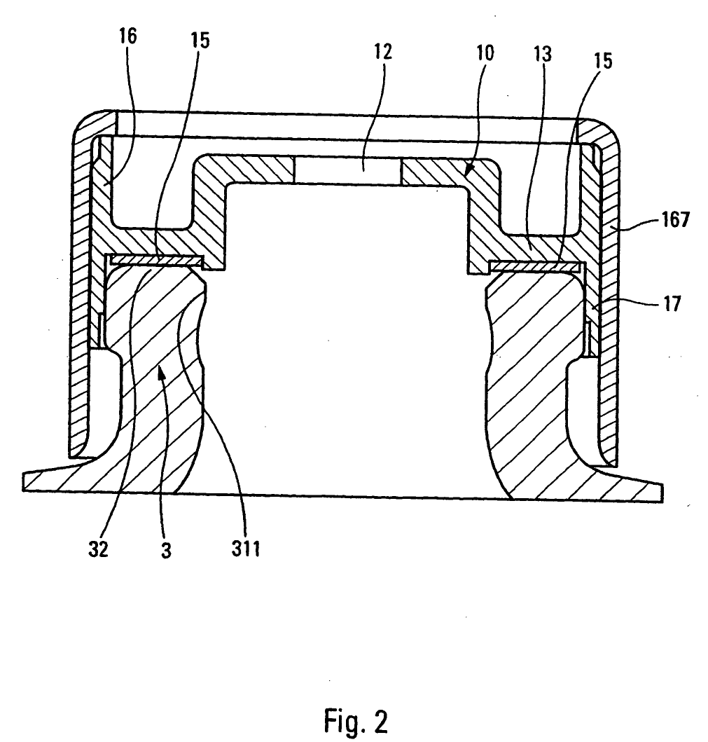

FIG. 2 is a view similar to the view in FIG. 1, but for a second embodiment of the invention.

FIG. 1 shows a dispenser member 2 which can be a pump or a valve. The dispenser member includes a body 20 forming a reinforced collar 21 at its top end. Beyond the collar, the dispenser member 2 forms a valve rod 22 designed to be covered by a dispenser head, which can be in the form of a push-button including a nozzle, for example. The reinforced collar 21 conventionally serves as a grip for fastening the dispenser member by means of the fastener device, as described below.

The reservoir is not shown in its entirety, with only the neck 3 being visible. The neck 3 has an inner wall 31, a top end-wall 32, and an outer wall 33. The top end-wall 32 can be completely plane as shown in FIG. 1, but it can also be formed with one or more concentric rings formed in relief. The top end-wall 32 is extended towards the inside of the neck by an annular bevel 321. Beyond the bevel, the inner wall 31 forms a narrow and substantially cylindrical opening section 311. Below the section 311, the inner wall 31 forms a slightly larger section 312 which is extended downwards by another substantially cylindrical section 313. In addition, the top end-wall 32 is extended outwards by a rounded section 322, which is itself extended by the outer wall 33. The outer wall 33 forms firstly a substantially cylindrical section 330 which is extended downwards by a shoulder 331. The shoulder 331 is connected to another section 332 having a diameter that is less than the diameter of the section 330. Such a configuration is quite conventional for a reservoir neck, and more particularly a reservoir neck made of glass. Glass is currently used to make flasks, and more generally, reservoirs in the fields of perfumery, cosmetics, or even pharmacy.

The fastener device, which is designated as a whole by the numerical reference 1, comprises a fastener ring 10 on which a covering band 167 is mounted. The fastener ring 10 is preferably made of plastics material, while the covering band 167 is preferably made of metal.

The fastener ring 10 comprises receiver means 11 which are in the form of a snap-fastener housing defined by a snap-fastener bead 111. The reinforced collar 21 of the dispenser member 2 is thus force-fitted into the housing, and is held therein by the snap-fastener bead 111. The snap-fastener housing is pierced with a through hole 12, through which the valve rod 22 of the dispenser member 2 passes. From the receiver means 11, the ring extends radially outwards so as to form an annular flange 13 which is in the form of an annular plate. At the junction between the receiver means 11 and the annular flange 13, the fastener ring is also extended downwards in the form of an inner sleeve 19. The snap-fastener bead 111 is situated at the top end of the inner sleeve 19 which extends freely downwards. The outer periphery of the annular flange 13 extends upwards so as to form a top bushing 16, and downwards so as to form an outer skirt 17. The outer skirt 17 can be continuous or it can be split in such a manner as to form vertical tabs that are separated by vertical slits. The bottom end of the skirt can be provided with a bead or with holding heads 18 which project radially inwards.

The covering band 167 is disposed around the ring, in contact with the bushing 16 and/or the skirt 17. By way of example, the band 167 can be fastened by clamping over at least a portion of the height of the bushing 16 and/or of the skirt 17. The top end of the band 167 can form an inwardly-directed abutment rim which stops its engagement on the ring.

In the invention, the annular flange 13 includes a bottom face which defines an application zone 14 coated in, or more generally provided with, an adhesive 15. The adhesive can be a paste, i.e. subject to creep, or it can be more solid, thereby substantially preserving its shape. By way of example, it should be observed that the application zone 14 is situated at the bottom of an annular groove formed by the inner sleeve 19 and the outer skirt 17 which extend substantially concentrically. The adhesive 15, which can be a glue, can thus be deposited easily on the bottom of the groove by holding the fastener ring upsidedown. The adhesive can also be in the form of a double-sided adhesive washer. Preferably, the adhesive or glue is applied, and contact is made cold, i.e. without the need to apply heat or for heat to be given off.

The adhesive 15 is designed to come into contact with the top end-wall 32 of the neck 3. While the ring 10 is being put in place on the neck, pressure can be exerted so that the adhesive 15 is pressed hard against the top end-wall 32 of the neck 3. As a function of the nature of the adhesive (glue, double-sided adhesive, etc.), said adhesive can be deformed to a greater or lesser extent over the top end-wall, so that a fraction of the adhesive can even flow over the bevel 321 or over the rounded outer section 322.

In addition, the outer wall 191 of the sleeve 19, which can also advantageously be made in frustoconical manner, comes into clamping contact against the narrow opening section 311 of the neck 3. More generally, the inner sleeve 19 must, via its outer wall 191, come into leaktight bearing contact against the inner wall 31 of the neck 3. It is particularly advantageous for the contact between the sleeve and the neck to be sealed, thereby isolating the fluid stored in the reservoir from the adhesive 15 which could contaminate it. In addition, the contact between the sleeve and the neck improves the strength and the stability of the ring 10.

With regard to the outer skirt 17, it can come into contact with the outer wall 33 of the neck 3. The contact can be optionally clamping and/or optionally leaktight. In the embodiment in FIG. 1, the skirt 17 is extended by its hook end 18 up to the shoulder 331 in such a manner as to become hooked thereon. This hook fastening is also blocked by the presence of the band 167.

The embodiment shown in FIG. 2 differs from the embodiment in FIG. 1 in that the ring 10 does not form an inner skirt 19, and in that the outer skirt 17 does not form a bottom end provided with a hook bead 18. Thus, both sealing and fastening are provided entirely by the adhesive 15 in leaktight contact with the top end-wall 32 of the neck 3. In addition, as a result of the skirt 17 not including a hook bead 18, the covering band 167 can be put in place on the ring prior to mounting the ring on the neck.

Naturally, from said two embodiments, it is possible to create variants which do not go beyond the ambit of the invention. For example, a ring could very well be made that has an inner sleeve 19, but that does not have a hook bead 18, and vice versa.

By means of the invention, a sealed fastening for fastening a fastener device on a reservoir neck can be made very simply and at low cost.

1. A fastener device (1) for fastening a fluid dispenser member (2) on a reservoir neck (3) having an inner wall (31) and a top end-wall (32), said fastener device including receiver means (10) adapted to receive a dispenser member (2) in secure manner, and fastener means (14, 15) capable of becoming engaged with the reservoir neck (3), the fastener means including an adhesive-coated application zone (14) capable of coming into contact with the reservoir neck (3), said device being characterized in that the adhesive-coated application zone (14) is designed to come into contact with the top end-wall (32) of the neck (3).

2. A device according to claim 1, including an annular flange (13) having a bottom face defining the application zone (14).

3. A device according to claim 1, including an inner sleeve (19) designed to come into leaktight engagement with the inner wall (31) of the neck (3).

4. A device according to claim 1, including an outer skirt (17) designed to extend around an outer wall (33, 332) of the neck (3).

5. A device according to claim 4, in which the outer skirt (17) includes hook means (18) capable of co-operating with the outer wall (33,332) of the neck (3).

6. A device according to claim 4, in which the outer skirt (17) is provided with a covering band (167).

7. A device according to claim 3, in which the inner sleeve (19) and the outer skirt (17) together form an annular groove having a bottom that is formed by the bottom face of the annular flange (13) which connects the sleeve to the skirt.

8. A device according to claim 1, in which the adhesive is a cold adhesive.

9. A fluid dispenser comprising a dispenser member (2), a reservoir (3), and a fastener device (1) according to claim 1.

10. A dispenser according to claim 9, in which the dispenser member is a pump, the reservoir is made of glass or of plastics material, and the fastener device is made of plastics material.
